(19) United States
(12) Patent Application Publication
(10) Pub. No.: US 2013/0136983 A1
(43) Pub. Date: May 30, 2013

(54) HYDROGEN ABSORBING ALLOY PARTICLES, ALLOY POWDER FOR ELECTRODE, AND ALKALINE STORAGE BATTERY

(71) Applicants: Kyoko Nakatsuji, Kanagawa (JP); Susumu Kikuyama, Kanagawa (JP); Masumi Katsumoto, Kanagawa (JP); Yoshitaka Dansui, Kanagawa (JP)

(72) Inventors: Kyoko Nakatsuji, Kanagawa (JP); Susumu Kikuyama, Kanagawa (JP); Masumi Katsumoto, Kanagawa (JP); Yoshitaka Dansui, Kanagawa (JP)

(73) Assignee: PANASONIC CORPORATION, Osaka (JP)

(21) Appl. No.: 13/813,808

(22) PCT Filed: Sep. 26, 2011
(86) PCT No.: PCT/JP2011/005387

§ 371 Date: Feb. 1, 2013

(30) Foreign Application Priority Data
Dec. 3, 2010 (JP) 2010-270825
Apr. 25, 2011 (JP) 2011-097425

(51) Int. Cl. H01M 4/38

(52) U.S. Cl. CPC H01M 4/383
USPC 429/218.2

(57) ABSTRACT

Disclosed is a hydrogen absorbing alloy particles including a matrix phase and a plurality of segregation phases, the matrix phase including an alloy having a CaCu₅ type crystal structure, the alloy including nickel (Ni) and 1 to 5 mass % of cobalt (Co); and the segregation phases including a magnetic material mainly composed of Ni and having an average particle diameter of 1 to 5 nm. A content of the segregation phases is preferably 0.05 to 0.5 mass %. Also, each of the segregation phases is preferably formed of a cluster of minute particles of the magnetic material.

### TECHNICAL FIELD

The present invention relates to hydrogen absorbing alloy particles having a CaCu₅ type crystal structure, an alloy powder for electrode including the same, and an alkaline storage battery using the alloy powder for electrode as a negative electrode active material. Specifically, the present invention relates to an improvement of the negative electrode active material for improving a low-temperature discharge capacity of the alkaline storage battery.

### BACKGROUND ART

Hydrogen absorbing alloys are capable of reversibly absorbing and desorbing hydrogen with the progress of charge and discharge, and they have a theoretical capacity density larger than that of cadmium. For this reason, hydrogen absorbing alloys are used as a negative electrode active material for an alkaline storage battery having a high energy density.

As the hydrogen absorbing alloys, a so-called AB₅ type hydrogen absorbing alloy having a CaCu₅ type crystal structure (also referred to as CaCu₅ type alloy, hereinafter) is known. Nickel-metal hydride secondary batteries which are alkaline storage batteries including the CaCu₅ type alloy as the negative electrode active material can be used as power sources for driving electric vehicles, etc.

It is known that the CaCu₅ type alloy is gradually pulverized, oxidized, and deteriorated with the progress of charge and discharge of the battery. In order to improve the charge and discharge cycle characteristics (cycle characteristics, hereinafter) of the alkaline storage batteries, a method of increasing a content of cobalt (Co) which is a CaCu₅ type alloy is known. Co suppresses expansion and contraction of crystal lattice of the CaCu₅ type alloy due to absorption and desorption of hydrogen.

Although the cycle characteristics of the alkaline storage batteries can be improved by increasing the Co content of the CaCu₅ type alloy, the discharge characteristics thereof lower. Also, Co, manganese (Mn), etc. in the CaCu₅ type alloy elute in the alkaline electrolyte, thereby accelerating deposition of these substances on the positive electrode and the separator. Consequently, occurrence of minor short circuit between the negative electrode and the positive electrode with this deposit therebetween is facilitated.

In order to solve the aforementioned problem, a method is proposed to suppress decline in the cycle characteristics and discharge characteristics of the battery while maintaining the Co content of the CaCu₅ type alloy at low level. Specifically, for example, Patent Literature 1 below discloses to change an axis a length and an axis c length corresponding to a ratio A/B of the AB₅ type hydrogen absorbing alloy in the CaCu₅ type alloy in which the axis a length and the axis c length of the crystal lattice are 499 pm or more and 405 pm or more, respectively, and a Co content is low. Also, Patent Literature 2 below discloses a CaCu₅ type alloy having a Co content of 5 mass % or less, a BET specific surface area of 0.3 to 0.7 m²/g, and an average particle diameter of 5 to 60 μm.

Meanwhile, as a technique of improving the cycle characteristics of the alkaline storage batteries, Patent Literature 3 below discloses a hydrogen absorbing alloy including a CaCu₅ type hydrogen absorbing alloy, magnetic clusters, and 20 to 70 mass % of nickel (Ni), in which the magnetic clusters include metal Ni and have an average particle diameter of 8 to 10 nm.

### CITATION LIST

### Patent Literature

[PTL 1] International Patent publication No. WO2005/14871
[PTL 2] Japanese Laid-Open Patent publication No. Hei 9-129227
[PTL 3] Japanese Laid-Open Patent publication No. 2007-115672

### SUMMARY OF INVENTION

### Technical Problem

When the CaCu₅ type alloy disclosed in Patent Literatures 1 and 2 is used as a negative electrode active material of an alkaline storage battery, the cycle characteristics and the discharge characteristics in a normal temperature environment are improved. However, the low-temperature discharge characteristics, particularly the discharge characteristics in a low-temperature environment of about 0° C. have not been improved sufficiently.

Also, Patent Literature 3 discloses that the cycle characteristics of an alkaline storage battery are improved by controlling an average particle diameter of magnetic clusters within a range of 8 to 10 nm in a hydrogen absorbing alloy including the CaCu₅ type hydrogen absorbing alloy and magnetic clusters. However, even when the hydrogen absorbing alloy disclosed in Patent Literature 3 is used as a negative electrode active material of an alkaline storage battery, the low-temperature discharge characteristics of the battery have not been improved sufficiently.

An object of the present invention is to provide hydrogen absorbing alloy particles used as a negative electrode active material of an alkaline storage battery in order to obtain an alkaline storage battery having excellent low-temperature discharge characteristics.

### Solution to Problem

An aspect of the present invention relates to hydrogen absorbing alloy particles comprising a matrix phase and a plurality of segregation phases, the matric phase comprising an alloy having a CaCu₅ type crystal structure, the alloy including Ni and 1 to 5 mass % of Co, the segregation phases comprising a magnetic material mainly composed of Ni and having an average particle diameter of 1 to 5 nm.

Another aspect of the present invention relates to an alloy powder for electrode including the aforementioned hydrogen absorbing alloy particles, the hydrogen absorbing alloy particles having a volume average particle diameter of 5 to 200 μm.

Still another aspect of the present invention relates to an alkaline storage battery comprising a positive electrode, a negative electrode, a separator disposed between the positive electrode and the negative electrode, and an alkaline electrolyte, the negative electrode including the aforementioned alloy powder for electrode as a negative electrode active material.

The objects, features, aspects, and advantages of the invention will be more explicit by the following detailed description and the appended drawings.

### Advantageous Effects of Invention

An alkaline storage battery using the hydrogen absorbing alloy particles of the present invention as a negative electrode active material has excellent low-temperature discharge characteristics.

### BRIEF DESCRIPTION OF DRAWINGS

FIG. 1A schematic sectional view illustrating schematically a part of a cross section of a hydrogen absorbing alloy particle in accordance with an embodiment of the present invention, and a state of an enlarged cross section of an observed segregation phase.

FIG. 2 A vertical sectional view illustrating schematically a structure of a nickel-metal hydride secondary battery in accordance with an embodiment of the present invention.

### DESCRIPTION OF EMBODIMENT

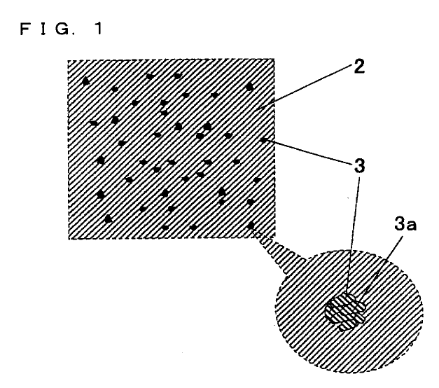

An embodiment of the hydrogen absorbing alloy particles in accordance with the present invention will be described in detail. As illustrated in FIG. 1, the hydrogen absorbing alloy particles of this embodiment include a matrix phase 2 and a plurality of segregation phases 3. The matrix phase 2 includes an alloy having a CaCu₅ type crystal structure and including Ni and 1 to 5 mass % of Co. The segregation phases 3 comprise a magnetic material mainly composed of Ni and have an average particle diameter of 1 to 5 nm. Each of the segregation phases 3 is observed in the form of a cluster of minute particles 3a of crystallite or amorphous portion of the magnetic material. It is considered that such a cluster, by allowing its Co content to be reduced, is formed of minute particles including: Ni that is deposited due to the content of a site B in an AB₅ type crystal structure, deviating from the stoichiometric content; and very small amounts of components other than Ni. When such a structure is observed clearly by observation with a high resolution transmission electron microscope, a catalytic activity toward hydrogen absorption reaction at a low temperature described below is particularly enhanced.

In the hydrogen absorbing alloy particles of this embodiment, the alloy having the CaCu₅ type crystal structure of the matrix phase includes 1 to 5 mass % of Co in order to improve the cycle characteristics of the alkaline storage battery. Also, the hydrogen absorbing alloy particles of this embodiment includes segregation phases formed of a magnetic material mainly composed of Ni and having an average particle diameter of 1 to 5 nm in order to improve low-temperature discharge characteristics. The average particle diameter of the segregation phases affects the low-temperature discharge characteristics of the alkaline storage battery.

As described later, the average particle diameter of the segregation phases formed of the magnetic material mainly composed of Ni can be controlled by production conditions of the hydrogen absorbing alloy particles. By controlling the average particle diameter of the segregation phases in a range of 1 to 5 nm, hydrogen absorption and desorption ability of the hydrogen absorbing alloy particles in the low-temperature environment is improved. Also, the segregation phases having such an average particle diameter can maintain the catalytic action activating dissociation of hydrogen molecules and bonding of hydrogen atoms in the matrix phase to a high level even in the low-temperature environment.

The matrix phase included in the hydrogen absorbing alloy particles includes an alloy having a CaCu₅ type crystal structure and including Ni and 1 to 5 mass % of Co (also referred to as matrix alloy, hereinafter).

A Co content in the matrix alloy is 1 to 5 mass %. Specifically, the Co content is 5 mass % or less, preferably 4.5 mass % or less, more preferably 4 mass % or less. Further, the Co content is 1 mass % or more, preferably 1.5 mass % or more. These lower and upper limit values can be combined appropriately. The Co content may be, for example 1 to 4 mass %, or 1.5 to 4.5 mass %. When the Co content exceeds 5 mass %, an elution amount of Co into the alkaline electrolyte in the alkaline storage battery increases in an early stage. Consequently, a large amount of Co is deposited on the separator and the positive electrode in an early stage. As a result, minor short circuit is likely to occur between the positive electrode and the negative electrode. In contrast, when the Co content is less than 1 mass %, expansion and contraction of crystal lattice due to absorption and desorption of hydrogen is not suppressed sufficiently. Therefore, the cycle characteristics are not improved sufficiently.

Meanwhile, a Ni content in the matrix alloy is preferably 20 to 65 mass %, more preferably 45 to 65 mass %. When the Ni content is in such a range, decline in the activity of the hydrogen absorbing alloy particles of absorbing and desorbing hydrogen can be suppressed more effectively. Consequently, the hydrogen absorbing alloy particles can be used more suitably as the negative electrode active material of the battery. Also, increase in the hydrogen equilibrium pressure in the battery can be suppressed more effectively, whereby the output of the battery can be ensured easily. When the Ni content is too low, the ability of the hydrogen absorbing alloy particles to absorb and desorb hydrogen tends to decline. In contrast, when the Ni content is too high, the hydrogen equilibrium pressure in the alkaline storage battery is increased, which tends to lower the output of the alkaline storage battery.

As described above, due to the fact that the matrix alloy includes Ni and Co in the above contents, the battery capacity and the cycle characteristics of the alkaline storage battery can be maintained sufficiently. Further, occurrence of minor short circuit caused by deposition of Co on the positive electrode and the separator in an early stage can be suppressed.

The alloy having the CaCu₅ type crystal structure preferably includes a misch metal (Mm) which is a mixture of two or more rare-earth elements, Mn, and Al in addition to Ni and Co described above. The contents of Mm, Mn, and Al in the alloy having the CaCu₅ type crystal structure are not particularly limited, and preferably, for example 20 to 40 mass % of misch metal, 3 to 7 mass % of Mn, and 1 to 3 mass % of Al. By including Mn and Al, the equilibrium pressure at the time when the hydrogen absorbing alloy particles absorb and desorb hydrogen can be lowered. As a result, the internal pressure of the alkaline storage battery can be lowered.

Specific examples of the alloy having the CaCu₅ type crystal structure include a hydrogen absorbing alloy based on MmNi₅ (where Mm represents a misch metal), in particular, a hydrogen absorbing alloy having a composition in which a part of Ni in MmNi₅ is replaced by Co, Mn, and Al.

Also, specific examples of the misch metal include a mixture including at least two or more rare-earth elements selected from cerium (Ce), lanthanum (La), praseodymium (Pr), and neodymium (Nd), etc. Further, examples of the misch metal include a misch metal including 10 to 20 mass % of Ce and 60 to 80 mass % of La, and further including appropriate amounts of Pr, Nd, etc.

The misch metal, niobium, zirconium, etc. usually exist in a site A of the AB₅ type alloy. Ni, Co, Mn, Al, etc. usually exist in a site B.

Examples of the composition in which a part of Ni in MmNi₅ is replaced by Co, Mn, and Al include a composition represented by MmNiₐCo_{b}Mn_{c}Al_{d} (where 3.5≦a≦4.5, 0.1≦b≦0.4, 0.3≦c≦0.5, 0<d≦0.4 and 4.9≦a+b+c+d≦5.4), specifically, MmNi_{4.2}Cu_{0.4}Mn_{0.4}Al_{0.3}, and MmNi_{4.5}Cu_{0.2}Mn_{0.3}Al_{0.3}. The alloy having the CaCu₅ type crystal structure can be used singly or in combination of two or more.

The plurality of segregation phases formed of the magnetic material included in the hydrogen absorbing alloy particles comprises a ferromagnetic material mainly composed of metal nickel (nickel simple substance). The segregation phases of the magnetic material mainly composed of metal nickel segregate on a surface layer portion of the hydrogen absorbing alloy particles, aggregate in the crystal or amorphous form, and preferably form clusters of minute particles of the magnetic material. The segregation phases of the magnetic material catalyze transfer reaction (absorption and desorption) of hydrogen by the hydrogen absorbing alloy.

The hydrogen absorbing alloy particles of this embodiment preferably comprise aggregates of magnetic material in which segregation phases in the form of clusters formed of minute particles 3a of crystallite or amorphous portion of magnetic material are dispersed in the particles, as illustrated in the enlarged view of FIG. 1. In this case, a cluster forms a segregation phase. The dispersion state of the segregation phases is not particularly limited. For example, the segregation phases may exist either on an inner portion or on a surface of the hydrogen absorbing alloy, or may exit on a surface layer portion of the hydrogen absorbing alloy.

The segregation phases formed of the magnetic material have an average particle diameter of 1 to 5 nm. The segregation phases formed of the magnetic material having such an average particle diameter has a high catalytic ability toward the transfer reaction of hydrogen in the hydrogen absorbing alloy including 1 to 5 mass % of Co, and particularly exhibit a sufficient catalytic ability even in the low-temperature environment.

When the average particle diameter of the segregation phases formed of the magnetic material is less than 1 nm, the catalytic activity of the segregation phases formed of the magnetic material lowers, and in order to enhance the catalytic activity, it is necessary to activate the catalytic action by repeating charge and discharge, for example. Meanwhile, when the average particle diameter of the segregation phases formed of the magnetic material exceeds 5 nm, the catalytic activity of the segregation phases formed of the magnetic material lowers. Therefore, when the average particle diameter of the segregation phases formed of the magnetic material is less than 1 nm and more than 5 nm, the low-temperature discharge characteristics of the battery lower. In particular, when a high-output discharge with the current value exceeding 5 It is performed in the low-temperature environment, the capacity decrease of the battery becomes distinct and sufficient low-temperature discharge characteristics cannot be obtained.

The particle diameter of the segregation phases formed of the magnetic material can be determined by taking a photograph of a cross section of the hydrogen absorbing alloy particle by a transmission electron microscope (TEM) and image processing the obtained photograph. In the image processing, for example the smallest circle surrounding completely the entire of one segregation phase in the cluster form is determined and the diameter of the smallest circle is defined as the particle diameter of the segregation phase. Measurements are performed in three visual fields and the particle diameters of 200 segregation phases selected randomly in each visual field are measured. Then, an average value of all the measured values of the obtained particle diameters is defined as the average particle diameter.

The average particle diameter of the segregation phases formed of the magnetic material is 1 nm or more, preferably 1.3 nm or more, more preferably 1.45 nm or more. Further, the average particle diameter of the segregation phases formed of the magnetic material is 5 nm or less, preferably 4.7 nm or less, more preferably 4 nm or less. These upper and lower limit values can be combined voluntarily. For example, the average particle diameter of the segregation phases formed of the magnetic material may be 1.45 to 5 nm.

A content of the segregation phases formed of the magnetic material in the hydrogen absorbing alloy particles is preferably 0.05 to 0.5 mass %, more preferably 0.1 to 0.4 mass % from the point that the segregation phases formed of the magnetic material exhibit a catalytic ability for a long time.

The content of the magnetic material in the hydrogen absorbing alloy particles can be determined by saturation magnetization in a magnetic field of 10 kOe, for example. Although the segregation phases formed of the magnetic material may include a very small amount of metal cobalt, etc., the saturation magnetization approximates one based entirely on metal nickel. Then, the nickel amount calculated from the saturation magnetization is defined as the content of the segregation phases formed of the magnetic material.

Next, a method of producing an alloy powder including the hydrogen absorbing alloy particles of this embodiment will be described in detail.

An alloy powder including hydrogen absorbing alloy particles can be produced by a production method including a raw material mixing step, a melting step, a cooling step, a heat treatment step, and a grinding step, for example. The average particle diameter of the segregation phases formed of the magnetic material can be controlled by adjusting production conditions, specifically cooling conditions in the cooling step, heat treatment conditions in the heat treatment step, etc.

The raw material mixing step is a step for mixing raw materials such as metal simple substances and misch metals so as to have composition of elements included in the objective hydrogen absorbing alloy particles. Examples of the simple metals include Ni, Co, Mn, and Al. The forms of various raw materials are not particularly limited. As the mixing, a known mixing method can be used without particular limitations.

The melting step is a step for obtaining a molten material by heat melting a raw material mixture prepared in the raw material mixing step. Specifically, the heat melting step is a step for melting the raw material mixture at a temperature of melting point or higher of each component of the raw material mixture by using a high frequency melting furnace, for example.

The cooling step is a step for obtaining a solidified body of the hydrogen absorbing alloy by cooling and solidifying the molten material obtained in the melting step. In this cooling step, by controlling the cooling conditions, the particle diameter of the segregation phases included in the obtained hydrogen absorbing alloy particles is adjusted. Specifically, the cooling rate of the molten material can be selected in a range of, for example 1×10³ to 1.5×10⁵° C./second, preferably 5×10³ to 1×10⁵° C./second, more preferably 8×10³ to 1×10⁵⁰C/second.

The heat treatment step is a step for heat treating the solidified body of the hydrogen absorbing alloy obtained in the cooling step in an inert gas atmosphere at a predetermined temperature. In the heat treatment step, the composition of the CaCu₅ type alloy is homogenized further. Also, by controlling the heat treatment conditions, the particle diameter of the segregation phases included in the obtained hydrogen absorbing alloy particles changes. The heat treatment temperature is preferably, for example 900° C. or more, more preferably 950° C. or more, particularly preferably 1,000° C. or more. Also, the heat treatment temperature is preferably, for example 1,200° C. or less, more preferably 1,150° C. or less, particularly preferably 1,100° C. or less. These lower and upper limits can be combined voluntarily. For example, the heat treatment temperature may be 1,000 to 1,100° C. Also, the heat treatment time is preferably in a range of 3 to 7 hours, more preferably 5 to 7 hours depending on the heat treatment temperature. Further, specific examples of the inert gas include helium, neon, argon, krypton, xenon, and nitrogen.

In the grinding step, the solidified body of the hydrogen absorbing alloy that has been heat treated in the heat treatment step is subjected to wet grinding or dry grinding, and the obtained ground material is classified as necessary. The grinding may be performed by combining wet grinding and dry grinding. Thus, the alloy powder of the present invention is obtained.

The average particle diameter of the hydrogen absorbing alloy particles is, for example 500 μm or less, preferably 5 to 200 μm, more preferably 10 to 100 μm.

As described above, the segregation phases formed of the magnetic material generate and grow mainly in the cooling step and the heat treatment step. Therefore, by producing the hydrogen absorbing alloy particles under the aforementioned production conditions, a powder of the hydrogen absorbing alloy particles including the segregation phases formed of the magnetic material having an average particle diameter of 1 to 5 nm can be obtained. It is to be noted that, in the grinding step, a face not in contact with air may appear and the segregation phases formed of the magnetic material may generate and grow on the face. Even in such a case, by selecting respective conditions of the cooling step and the heat treatment step within the aforementioned ranges, the hydrogen absorbing alloy particles including the segregation phases formed of the magnetic material having a predetermined average particle diameter can be obtained.

The alloy powder after grinding may further be subjected to an alkaline treatment. By the alkaline treatment, the ability of the hydrogen absorbing alloy particles to absorb and desorb hydrogen can be activated further. The alkaline treatment is performed by making the powder of the hydrogen absorbing alloy particles after grinding in contact with an alkaline agent such as potassium hydroxide and subsequently water washing and drying the powder. Also, when an alkaline storage battery is produced by using a non-alkaline treated powder of hydrogen absorbing alloy particles as the negative electrode active material, the hydrogen absorbing alloy particles are brought in contact with the alkaline electrolyte and activated in the alkaline storage battery.

The hydrogen absorbing alloy particles obtained as above is preferably used as the negative electrode active material used in the alkaline storage battery. In the alkaline storage battery of this embodiment, conventionally used elements of the alkaline storage battery are used as they are except that the aforementioned hydrogen absorbing alloy particles are used as the negative electrode active material. In the following, a nickel metal-hydride secondary battery will be described as an example of the alkaline storage battery of this embodiment.

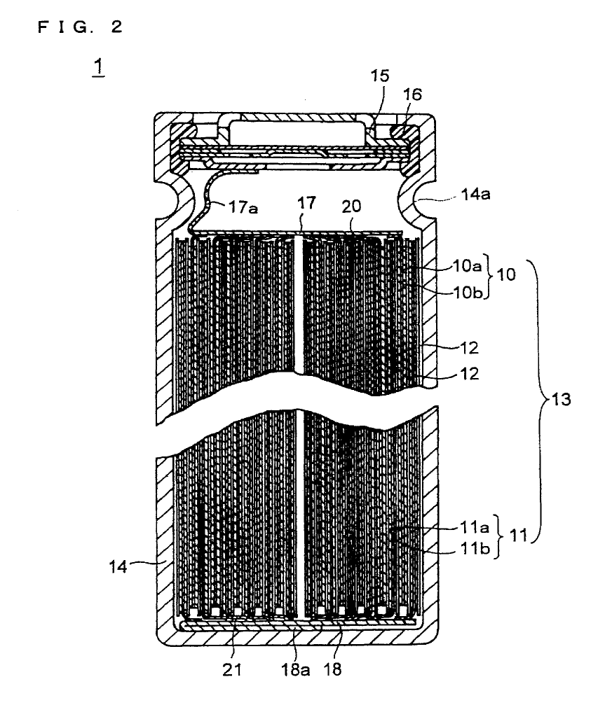

FIG. 2 is a vertical sectional view illustrating schematically the constitution of a nickel-metal hydride secondary battery 5 of this embodiment. As each of the elements used in the nickel-metal hydride secondary battery of this embodiment, elements of a conventionally known nickel-metal hydride secondary battery can be used without particular limitations except that the aforementioned hydrogen absorbing alloy particles are used as the negative electrode active material.

In FIG. 2, a nickel-metal hydride secondary battery 1 includes: a positive electrode 10 having a positive electrode material mixture 10a including a positive electrode active material and a positive electrode core material 10b; a negative electrode 11 having a negative electrode material mixture 11a including a negative electrode active material and a negative electrode core material 11b; and a separator 12. A laminate of the positive electrode 10, the negative electrode 11, and the separator 12 disposed therebetween is wound to form an electrode group 13. The electrode group 13 is housed in a battery case 14 which is a cylindrical can with a bottom. An exposed portion of the positive electrode side not facing the positive electrode material mixture 10a is provided on one end portion along the lengthwise direction of the positive electrode core material 10b. In the same manner, an exposed portion of the negative electrode side not facing the negative electrode material mixture 11a is provided on one end portion along the lengthwise direction of the negative electrode core material 11b. Then, the electrode group 13 is housed such that the exposed portion of the positive electrode side is located on one end face 20 of the battery case 14 and the exposed portion of the negative electrode side is located on the other end face 21. A positive current collector plate 17 is welded to the exposed portion of the positive electrode side and a negative current collector plate 18 is welded to the exposed portion of the negative electrode side, respectively. Further, the positive current collector plate 17 is welded to a sealing plate 15 serving as an outer terminal of the positive electrode via a positive lead 17a. The negative current collector plate 18 is welded to a bottom surface of the battery case 14 serving as an outer terminal of the negative electrode via a negative lead 18a. A groove portion 14a which is a depression is formed on an outer circumference near an opening of the battery case 14, and an opening end of the battery case 14 is sealed by mounting the sealing plate 15 with a gasket 16 therebetween and caulking. Before sealing, an alkaline electrolyte is injected into the battery case 14.

As the positive electrode active material, a nickel compound such as nickel hydroxide and nickel oxyhydroxide is used. As the negative electrode active material, the aforementioned hydrogen absorbing alloy particles of this embodiment are used. Also, as the alkaline electrolyte, for example a solution including potassium hydroxide, sodium hydroxide or lithium hydroxide is used. As the negative electrode active material, other known negative electrode active material may be included unless the effect of the present invention is impaired.

Since the alkaline storage battery of this embodiment as described above has favorable discharge characteristics in the low-temperature environment of about 0° C., it can maintain a high output as described in Examples below. Therefore, it can be suitably used as a power source for driving transport machines that are also used in a cold district such as electric vehicles and hybrid electric vehicles.

### EXAMPLES

Next, the present invention will be described by referring to Examples. It should be noted that the scope of the present invention is not limited by the following Examples.

### Example 1

First, preparation of the powder of the hydrogen absorbing alloy particles will be described in detail.

### (Preparation of Alloy Powder)

Powders of a misch metal including 15 mass % of Ce, 80 mass % of La, and a residue of Pr and Nd, Ni simple substance, Co simple substance, Mn simple substance, and Al simple substance were mixed in predetermined proportions. Then, the obtained mixture was introduced in a high frequency melting furnace and heated to 1,500° C. to be molten. Subsequently, the obtained molten material was cooled at a cooling rate of 1×10⁴° C./second to give a solidified body. The obtained solidified body was represented by a composition of MmNi_{4.2}Co_{0.4}Mn_{0.4}Al_{0.3}. Then, the obtained solidified body was heat treated under conditions of a heat treatment temperature of 950° C. and a heat treatment time of 6 hours, as shown in Table 1 below.

Subsequently, the solidified body after the heat treatment was ground by a jaw crusher to give coarse particles including hydrogen absorbing alloy particles having an average particle diameter of less than 500 μm. Then, an average particle diameter and a content of the segregation phases included in the hydrogen absorbing alloy particles, and contents of each of Co and Ni included in the alloy having the CaCu₅ type crystal structure were calculated.

### <Measurement of Average Particle Diameter of Segregation Phases>

The coarse particles were classified to collect hydrogen absorbing alloy particles within a range of 20 to 53 μm. The classified hydrogen absorbing alloy particles and an epoxy resin were mixed to prepare a paste. Then, this paste was sandwiched by 2 silicon wafers. Subsequently, the epoxy resin was left for 5 hours to be cured, thereby giving a sandwiched body. The obtained sandwiched body was mechanical polished, whereby a cross section where the hydrogen absorbing alloy particles were embedded in the epoxy resin was exposed as a polished surface. Therefore, the polished surface was subjected to an ion milling treatment by using a precision polishing apparatus (trade name: PIPS691, available from GATAN, Inc), whereby an observation sample was obtained.

Then, the polished surface of the observation sample was observed by a high-resolution transmission-type electron microscope. As the high-resolution transmission-type electron microscope, H-9000UHR (trade name, available from Hitachi, Ltd.) was used and an acceleration voltage was set at 300 kV. A crystal lattice interval of the magnetic material mainly composed of Ni in the hydrogen absorbing alloy particles is different from a crystal lattice interval of the alloy having the CaCu₅ type crystal structure. Consequently, the segregation phases formed of the magnetic material mainly composed of Ni was reflected darkly and the alloy having the CaCu₅ type crystal structure was reflected brightly. The hydrogen absorbing alloy particles included numerous segregation phases formed of clusters which are aggregates of crystallite or amorphous minute particles of the magnetic material mainly composed of Ni. Subsequently, a diameter of the smallest circle surrounding completely the dark area representing each segregation phase was measured. It is possible to say that the diameter of the smallest circle is the largest diameter of each segregation phase. The diameter of this smallest circle is defined as the particle diameter of the segregation phase. Then, the particle diameters of the segregation phases observed in images of 3 visual fields were measured. At this time, the particle diameters of about 200 segregation phases were measured per one visual field, and the particle diameters of a total of about 600 segregation phases were measured. Then, a value obtained by averaging the particle diameters of the 600 segregation phases was defined as an average particle diameter. The average particle diameter of the segregation phases was 1.02 nm.

TABLE 1

| | Cooling | Heat | Heat | Average particle |
|---|---|---|---|---|
| | rate | treatment | treatment | diameter of |
| | (° C./ | temperature | time | segregation phases |
| | second) | (° C.) | (hour) | (nm) |
| Co. Ex. 1 | 10² | 1000 | 6 | 0.70 |
| Example 1 | 10⁴ | 950 | 6 | 1.02 |
| Example 2 | 10⁴ | 1000 | 6 | 1.45 |
| Example 3 | 10⁴ | 1050 | 6 | 2.11 |
| Example 4 | 10⁴ | 1075 | 6 | 2.50 |
| Example 5 | 10⁴ | 1100 | 6 | 3.22 |
| Example 6 | 10⁵ | 1100 | 6 | 4.51 |
| Example 7 | 10³ | 1050 | 6 | 3.50 |
| Example 8 | 10³ | 1050 | 6 | 2.61 |
| Co. Ex. 2 | 10⁴ | 1150 | 6 | 6.13 |
| Co. Ex. 3 | 10² | 1050 | 6 | 3.81 |
| Co. Ex. 4 | 10³ | 1050 | 6 | 6.21 |
| Co. Ex. 5 | 10³ | 1050 | 6 | 2.55 |

Further, a content of the segregation phases in the hydrogen absorbing alloy particles was measured by using a sample vibration type magnetometer (trade name: VSM-C7-10A, available from Toei Industry Co., Ltd.). Specifically, saturation magnetization of the powder of the hydrogen absorbing alloy particles in a magnetic field of 10 kOe was determined, and an amount of metal Ni corresponding to the obtained saturation magnetization was determined, whereby a content of the segregation phases was calculated. Then, the composition of the alloy having the CaCu₅ type crystal structure was specified from the content and the raw material composition of metal Ni. The content of the segregation phases was 0.31 mass %, the content of Ni in the alloy having the CaCu₅ type crystal structure was 60 mass %, and the content of Co was 3 mass %. From these compositions, the composition of the alloy having the CaCu₅ type crystal structure was specified as MmNi_{4.2}Cu_{0.4}Mn_{0.4}Al_{0.3}.

TABLE 2

| | Alloy having CaCu₅ type | | |
|---|---|---|---|
| | crystal structure | Segregation phases | |
| | Ni Content | Co content | Content |
| | (mass %) | (mass %) | (mass %) |
| Co. Ex. 1 | 60 | 3 | 0.30 |
| Example 1 | 60 | 3 | 0.31 |
| Example 2 | 60 | 3 | 0.33 |
| Example 3 | 60 | 3 | 0.50 |
| Example 4 | 60 | 3 | 0.35 |
| Example 5 | 60 | 3 | 0.42 |
| Example 6 | 60 | 3 | 0.41 |
| Example 7 | 65 | 1 | 0.50 |
| Example 8 | 20 | 5 | 0.11 |
| Co. Ex. 2 | 60 | 3 | 0.30 |
| Co. Ex. 3 | 50 | 10 | 0.65 |
| Co. Ex. 4 | 68 | 0 | 0.67 |
| Co. Ex. 5 | 18 | 10 | 0.04 |

### (Production and Evaluation of Alkaline Storage Battery)

### (1) Production of Negative Electrode

To 100 parts by mass of coarse particles of the obtained hydrogen absorbing alloy particles, 250 parts by mass of acetone and an appropriate amount of water were mixed, and the coarse particles were ground to have a maximum particle diameter of 75 μm or less by a wet type ball mill. The hydrogen absorbing alloy particles after grinding had a volume average particle diameter of 20 μm. Then, the hydrogen absorbing alloy particles after grinding was activated by an alkaline treatment in which the hydrogen absorbing alloy particles after grinding was subjected to a stirring treatment in an aqueous solution of potassium hydroxide. After the alkaline treatment, the hydrogen absorbing alloy particles were washed with water and dried.

Then, 100 parts by mass of the alkaline treated powder of the hydrogen absorbing alloy particles, 0.15 parts by mass of carboxymethyl cellulose (etherification degree 0.7, polymerization degree 1,600), 0.3 parts by mass of carbon black, and 0.7 parts by mass of styrene-butadiene copolymer were mixed, and an appropriate amount of water was mixed further with the obtained mixture, whereby a negative electrode material mixture paste was prepared. Subsequently, the negative electrode material mixture paste was applied onto both surfaces of a core material made of a nickel-plated iron perforated metal (thickness 60 μm, pore diameter 1 mm, porosity 42%). The obtained coating film was dried and then roller pressed with the core material. In this manner, a negative electrode having a thickness of 0.4 mm, a width of 35 mm, and a capacity of 2,200 mAh was obtained. An exposed portion of the core material was provided on one end portion along the lengthwise direction of the negative electrode, and a negative lead was welded to the exposed portion.

### (2) Production of Battery

As the positive electrode, a sintered nickel positive electrode having a width of 35 mm and a capacity of 1,500 mAh on which an exposed portion of the core material is provided on one end portion along the lengthwise direction was used. A positive lead was welded to the exposed portion of the positive electrode. As the separator, a nonwoven cloth made of polypropylene having a thickness of 100 μm was used. As the alkaline electrolyte, an alkaline electrolyte prepared by dissolving 5 mol of potassium hydroxide, 1 mol of sodium hydroxide, and 0.5 mol of lithium hydroxide in 1 liter of water was used.

In order to produce the alkaline storage battery as illustrate in FIG. 2, a laminate including the positive electrode, the negative electrode, and the separator was wound to form a wound type electrode group. Then, the electrode group was housed in the battery case which was a cylindrical can. At this time, the negative lead of the electrode group was connected with a bottom surface of the battery case which served as the negative electrode. Also, the positive lead of the electrode group was connected with the sealing plate serving as the positive electrode, which was to be caulked with the opening of the battery case. Subsequently, 2 ml of alkaline electrolyte was injected into the battery case. Then, the sealing plate was mounted on the opening of the battery case with a gasket therebetween, and the battery case was caulked to be sealed. In this manner, a cylindrical nickel-metal hydride secondary battery of 4/5A size which was a type of the alkaline storage battery as illustrated in FIG. 2 was produced. With this battery, first time charge and discharge (temperature: 25° C., charge conditions: at 150 mA for 15 hours, discharge conditions: at 450 mA for 3 hours) were performed. This battery had a nominal capacity at 25° C. of 1,500 mAh.

### (3) Evaluation of Battery

Low-temperature discharge characteristics of the obtained nickel-metal hydride secondary battery were evaluated in the following manner. The nickel-metal hydride secondary battery was charged for 4 hours at 0.2 lt (0.3 A) in an environment of 25° C. The battery voltage after the charge for 4 hours was 1.45 V. Then, after a rest of 15 minutes, the battery was discharged at 6 it (9 A) in an environment of 0° C. until the battery voltage reached 1.0 V. In the same manner, a discharge capacity before the battery voltage reached 1.0 V at the time when the discharge current value was changed gradually from 6 it (9 A) to 10 it (15 A) was evaluated. The results are shown in Table 3.

The discharge capacity at 0° C. (standard value) at each discharge current value was defined as 1, and the discharge capacity at each discharge current value was evaluated as a ratio to this standard value.

TABLE 3

| Discharge current (A) | | 9 | 10.5 | 12 | 13.5 | 15 |
|---|---|---|---|---|---|---|
| Low- | Co. Ex. 1 | 1 | 1 | 0.90 | 0.85 | 0.70 |
| temperature | Example 1 | 1.05 | 1 | 1 | 1 | 1 |
| discharge | Example 2 | 1.05 | 1.05 | 1.05 | 1 | 1 |
| capacity | Example 3 | 1.05 | 1.05 | 1.05 | 1 | 1 |
| ratio | Example 4 | 1.10 | 1.10 | 1.10 | 1 | 1 |
| | Example 5 | 1.05 | 1.05 | 1.05 | 1 | 1 |
| | Example 6 | 1.05 | 1.05 | 1 | 1 | 1 |
| | Example 7 | 1.05 | 1.05 | 1.05 | 1 | 1 |
| | Example 8 | 1.05 | 1 | 1 | 1 | 1 |
| | Co. Ex. 2 | 1 | 1 | 0.85 | 0.80 | 0.65 |
| | Co. Ex. 3 | 1 | 1 | 0.80 | 0.75 | 0.60 |
| | Co. Ex. 4 | 1 | 1 | 0.85 | 0.80 | 0.70 |
| | Co. Ex. 5 | 0.95 | 0.85 | 0.80 | 0.75 | 0.60 |

### Examples 2 to 8 and Comparative Examples 1 to 5

Nickel-metal hydride secondary batteries were produced in the same manner as in Example 1 except that the cooling temperature, the heat treatment temperature, and the heat treatment time were selected as shown in Table 1. Also, in Examples 7 and 8 and Comparative Examples 3 to 5, by further changing the compositions, the contents of Ni and Co in the hydrogen absorbing alloy were changed as shown in Table 2. The results are shown in Tables 1 to 3.

From Table 3, it is found that when the hydrogen absorbing alloys of Examples 1 to 8 in accordance with the present invention were used, favorable low-temperature discharge characteristics were obtained. Also, in Comparative Examples 1, 2, and 4 in which the average particle diameter of the segregation phases was outside the range of 1 to 5 nm, the low-temperature discharge characteristics were inferior. The reason for this is considered that hydrogen supply speed of the negative electrode to the positive electrode became slower because the catalytic ability of the segregation phases which were the magnetic material included in the hydrogen absorbing alloy particles declined. Further, it is found that, even when the average particle diameter of the segregation phases is in the range of 1 to 5 nm, if the Co content exceeds 5 mass % as in Comparative Examples 3 and 5, favorable low-temperature discharge characteristics cannot be obtained.

As described above, it is found that an alkaline storage battery having excellent low-temperature discharge characteristics can be obtained by using the hydrogen absorbing alloy particles in accordance with the present invention as the negative electrode active material.

### INDUSTRIAL APPLICABILITY

The hydrogen absorbing alloy particles of the present invention are useful as a negative electrode active material of an alkaline storage battery such as a nickel-metal hydride secondary battery. Also, since the alkaline storage battery of the present invention is capable of high-output discharge even in a low-temperature environment of about 0° C. and at a discharge current of 10 A or more, it can be used, for example, as a power source for various electronic devices, transport machines such as electric vehicles and HEV, and storage equipment. Further, the alkaline storage battery of the present invention can be suitably used as a power source for tough use such as cogeneration for home and industrial uses.

### REFERENCE SIGNS LIST

1. Nickel-metal hydride secondary battery
2. Matrix phase
3. Segregation phase
10. Positive electrode
10a. Positive electrode material mixture
10b. Positive electrode core material
11. Negative electrode
11a. Negative electrode material mixture
11b. Negative electrode core material
12. Separator
13. Electrode group
14. Battery case
14a. Groove portion
15. Sealing plate
16. Gasket
17. Positive current collector plate
17a. Positive lead
18. Negative current collector plate
18a. Negative lead
20, 21. End faces of electrode group

1. Hydrogen absorbing alloy particles comprising a matrix phase and a plurality of segregation phases,
the matrix phase comprising an alloy having a CaCu₅ type crystal structure, the alloy including nickel (Ni) and 1 to 5 mass % of cobalt (Co), and
the segregation phases comprising a magnetic material mainly composed of Ni and having an average particle diameter of 1 to 5 nm.

2. The hydrogen absorbing alloy particles in accordance with claim 1, wherein a content of the segregation phases is 0.05 to 0.5 mass %.

3. The hydrogen absorbing alloy particles in accordance with claim 1, wherein each of the segregation phases comprises a cluster of minute particles of the magnetic material.

4. The hydrogen absorbing alloy particles in accordance with claim 1, wherein a Ni content of the alloy having the CaCu₅ type crystal structure is 20 to 65 mass %.

5. The hydrogen absorbing alloy particles in accordance with claim 1, wherein the alloy having the CaCu₅ type crystal structure further includes a misch metal (Mm), manganese (Mn), and aluminum (Al).

6. An alloy powder for electrode including the hydrogen absorbing alloy particles in accordance with claim 1, the hydrogen absorbing alloy particles having a volume average particle diameter of 5 to 200 μm.

7. An alkaline storage battery comprising a positive electrode, a negative electrode, a separator disposed between the positive electrode and the negative electrode, and an alkaline electrolyte,
the negative electrode including the alloy powder for electrode in accordance with claim 6 as a negative electrode active material.
